(19) United States
(12) Patent Application Publication
(10) Pub. No.: US 2007/0076049 A1
(43) Pub. Date: Apr. 5, 2007

(54) Array type printhead and inkjet image forming apparatus having the same

(75) Inventors: Seo-hyun Cho, Seongnam-si (KR); Myung-song Jung, Gunpo-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/507,484

(22) Filed: Aug. 22, 2006

(30) Foreign Application Priority Data
Oct. 5, 2005 (KR) 2005-93329

(51) Int. Cl. B41J 2/15

(52) U.S. Cl. 347/40

(57) ABSTRACT

An array printhead and an inkjet image forming device having the same. The array printhead includes a first member, a second member, and a third member. The first through third members sequentially overlap and couple to each other. The first member supplies ink of different colors to the second member and the second member separately receives the ink of different colors supplied from the first member and allows the ink to flow to the third member. The third member is mounted with a plurality of head chips on a lower surface thereof and the head chips have nozzles ejecting ink and forming a plurality of nozzle lines. The ink of different colors is supplied to the nozzle lines, respectively.

### CROSS-REFERENCE TO RELATED APPLICATIONS

This application claims the benefit of Korean Patent Application No. 10-2005-0093329, filed on Oct. 5, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus having an array printhead equipped with a nozzle unit of a length that corresponds to a width of printing medium.

2. Description of the Related Art

An inkjet image forming apparatus is an apparatus for ejecting ink to form an image using a printhead (shuttle type printhead) spaced apart from a front surface of paper and performing a reciprocating motion in a direction perpendicular to a feeding direction of paper. The printhead includes a nozzle unit where a plurality of nozzles that eject ink are formed.

Recently, attempts are being made to achieve a high-speed printing using a printhead (i.e., a line type printhead) having a nozzle unit of a length that corresponds to the width of paper instead of a printhead that reciprocates in a width direction of paper. In the above inkjet image forming apparatus, since the printhead is fixed and only paper is delivered, a driving mechanism is simple and a high-speed printing may be achieved.

FIG. 1 is a cross-sectional view illustrating a conventional printhead.

Referring to FIG. 1, a body 1 formed of a ceramic material includes a mounting part 3 in which a manifold 2 is mounted. The manifold 2 includes a space through which ink is supplied. The manifold 2 includes one inlet port 4 and two outlet ports 5 and 6, which are located with a predetermined interval so that ink may flow therethrough. Ink that enters through the inlet port 4 flows to an ink cartridge (not shown) through the outlet ports 5 and 6, so that ink circulates.

A nozzle unit 7 having a plurality of nozzles (not shown) is attached on one side of the manifold 2 and a printed circuit board (PCB) 8 is attached on the other side (i.e., the opposite side) of the manifold 2. The nozzle unit 7 is electrically connected to the PCB 8 to eject ink under the control of the PCB.

To form a color image, the conventional printhead has a structure where four manifolds 2 are mounted with a predetermined interval in the body 1. The manifolds 2 supply ink of colors Y (yellow), C (cyan), M (magenta), and K (black), respectively, to allow the ink to be ejected to an outside through the nozzle unit 7, so that the color image is formed.

However, a size of the body 1 formed of the ceramic material is excessively large and the manifolds 2 for supplying ink within the body 1 are formed of a metal such as aluminum, so that manufacturing costs increase. Also, since a degree of planarization of the body 1 should be managed for attachment of the nozzle unit 7 thereon, additional processes of locating a nickle (Ni) plating on the manifold 2 and then attaching the nozzle unit 7 on the manifold 2 are required, which increases manufacturing costs on the whole.

### SUMMARY OF THE INVENTION

The present general inventive concept provides an array type printhead having a plurality of head chips arranged in plural lines and an ink supply passage structure allowing ink of four colors to be supplied to respective head chips, and an inkjet image forming apparatus having the array type printhead.

Additional aspects and advantages of the present general inventive concept will be set forth in part in the description which follows and, in part, will be obvious from the description, or may be learned by practice of the general inventive concept.

The foregoing and/or other aspects of the present inventive concept may be achieved by providing an array printhead including a first member to supply ink of different colors into a second member, and the second member to separately receive the ink of different colors supplied from the first member and to allow the separately received ink to flow to a third member, wherein the first, second, and third members sequentially overlap and couple to each other, the third member includes, on a lower surface thereof, a plurality of head chips where nozzles ejecting ink form a plurality of nozzle lines, and the ink of different colors is supplied to the nozzle lines, respectively.

The foregoing and/or other aspects of the present inventive concept may also be achieved by providing an array printhead including a support member including through holes to allow ink to pass through the support member, an ink supply structure, attached to the support member and including ink inlet holes to reveive the ink passed through the support member and including one or more channels to direct the ink in a first direction and one or more pass grooves to direct the ink in a second direction, and a plurality of head chips scalably mounted to the ink supply structure to eject ink received through the one or more pass grooves.

The foregoing and/or other aspects of the present inventive concept may also be achieved by providing an array printhead including a plurality of head chips disposed in a lengthwise direction and having a plurality of nozzle lines disposed parallel to each other in a direction having an angle with the lengthwise direction and each having a plurality of nozzles disposed thereon, a member having an inlet, a channel disposed in the lengthwise direction to communicate with the inlet, a pass groove disposed in the direction to guide the ink from the channel in the direction, head chip mounting parts mounted with corresponding ones of the plurality of head chips to transfer the ink from the pass groove to the plurality of head chips, and a support member connected to the member to support the member in a body.

The foregoing and/or other aspects of the present inventive concept may also be achieved by providing an array printhead usable in an image forming apparatus including a first member extended in a lengthwise having a plurality of inlet holes disposed in the lengthwise direction and in a direction having an angle with the lengthwise direction, and having a plurality of channels extended in the lengthwise direction and parallel to each other to receive ink from corresponding ones of the plurality of inlet holes, a second member having a plurality of ink channels extended in the lengthwise direction to form ink passages with corresponding ones of the channels of the first member and having a plurality of pass grooves extended in the direction, a third member having a plurality of pass grooves extended in the direction to form another ink passage with corresponding ones of the pass grooves, and having a plurality of head chip mounting parts, a plurality of head chips mounted on corresponding ones of the plurality of head chip mounting parts, and a support member connected to the first, second, and third members to support the first, second, and third members in the direction and the lengthwise direction.

The foregoing and/or other aspects of the present inventive concept may also be achieved by providing an array printhead usable in an image forming apparatus including an ink structure disposed in a lengthwise direction of the array printhead to receive ink in a receiving direction, and to output the ink from a portion of the plane in an output direction a same as the receiving direction and to distribute and supply ink in a plane perpendicular to the receiving direction, and a plurality of head chips mounted on the ink structure and having nozzles to eject ink in an ejection direction on to the recording medium, the ejection direction being a same direction as the output direction.

The foregoing and/or other aspects of the present inventive concept may also be achieved by providing an inkjet image forming apparatus including a recording medium feeding unit to feed a recording medium in a feeding direction and in a feeding plane, an array printhead to eject ink in an ejection direction perpendicular to the feeding plane and onto the recording medium to form an image, the array printhead including an ink structure disposed in a lengthwise direction of the array printhead to receive ink in a receiving direction a same as the ejection direction and perpendicular to the feeding direction, and to distribute and supply ink in a plane parallel with the feeding plane, and to output the ink received in an output direction the same as the receiving direction, and a plurality of head chips mounted on the ink structure and having nozzles to eject ink in the ejection direction on to the recording medium.

The foregoing and/or other aspects of the present inventive concept may also be achieved by providing an inkjet image forming apparatus including a paper delivery element delivering paper in one direction, and an array printhead ejecting ink onto the paper to form an image, the array printhead having a first member supplying ink of different colors into a second member, and the second member separately receiving the ink of different colors supplied from the first member and allowing the separately received ink to flow to a third member, wherein the first through third members sequentially overlap and couple to each other, the third member mounts, on a lower surface thereof, a plurality of head chips where nozzles ejecting ink form a plurality of nozzle lines, and the ink of different colors is supplied to the nozzle lines, respectively.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional printhead;

FIG. 2 is a cross-sectional view illustrating an inkjet image forming apparatus having an array printhead according to an embodiment of the present inventive concept;

FIG. 3 is a perspective view illustrating the array printhead of FIG. 2;

FIG. 4 is a perspective view illustrating a backside of the array printhead of FIG. 3;

FIG. 5 is a plan view illustrating a head chip of the array printhead of FIG. 2;

FIG. 6 is a perspective view illustrating the array printhead of FIG. 2; and

FIG. 7 is a backside view illustrating the array printhead of FIG. 2.

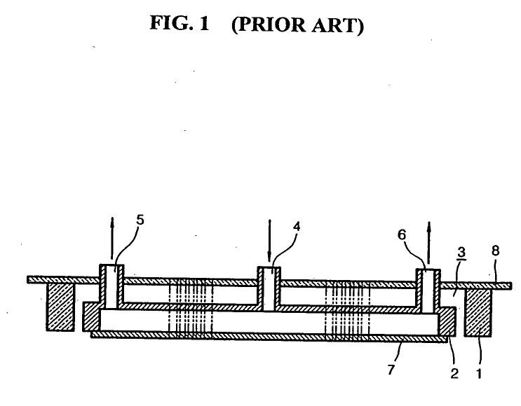

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

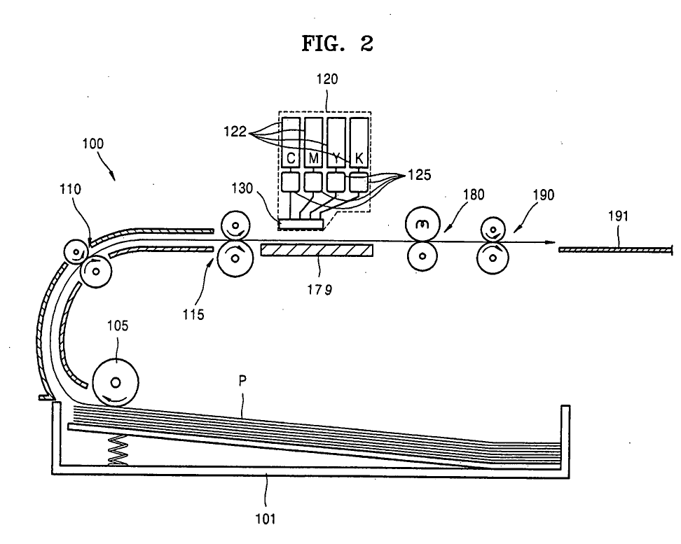

As illustrated in FIG. 2, an inkjet image forming apparatus 100 may include a paper-feeding part to feed a printing medium, such as a sheet of paper P, in one direction and an array printhead 130 to eject ink onto the paper P to form an image.

The paper-feeding part may include feeding rollers 110 to feed the paper P such that the paper P may pass through a paper path below the array printhead 130, and discharging rollers 190 to discharge the paper P on which an image is formed by ink ejection to a paper-discharging tray 191.

The feeding rollers 110 and the discharging rollers 190 respectively each have a pair of rollers which may include a driving roller and a driven roller pressed into contact with each other. The paper P progresses through a contact surface formed between the respective pairs of rollers. A reference number 115 may be registration rollers to align the paper P so as to form the image on a desired portion of the paper P.

The inkjet image forming apparatus 100 includes a paper-feed cassette 101 to stack the paper P thereon, and a pickup roller 105 to pick up the paper P stacked in the paper-feed cassette 101 sheet by sheet. Also, the apparatus 100 further may include a drier 180 to dry the image formed on the paper P by ink ejection. Since the apparatus 100 having the array printhead 130 may print images at high speed, the paper P may not be sufficiently dried and continuously stacked in the paper-discharging tray 191, which may cause ink spread. The drier 180 rapidly dries the image to prevent a printing defect due to the ink spread.

An ink cartridge 120 may be located between the registration rollers 115 and the drier 170.

The ink cartridge 120 may include four ink tanks 122C, 122M, 122Y, and 122K respectively receiving ink of four colors of cyan (C), magenta (M), yellow (Y), and black (K), four negative pressure regulators 125C, 125M, 125Y, and 125K, and the array printhead 130 therein.

The negative pressure regulators 125C, 125M, 125Y, and 125K regulate negative pressures of ink flowing to the array printhead 130 from the four ink tanks 122C, 122M, 122Y, and 122K to prevent air bubbles from penetrating into an inside of the array printhead 130 or prevent ink from leaking out unnecessarily.

A platen 179 is located below the array printhead 130 to support the paper P containing an image thereon and passing through the paper path below the array printhead 130. By use of the platen 179, a uniform interval is maintained between the array printhead 130 and the paper P passing through the paper path below the array printhead 130.

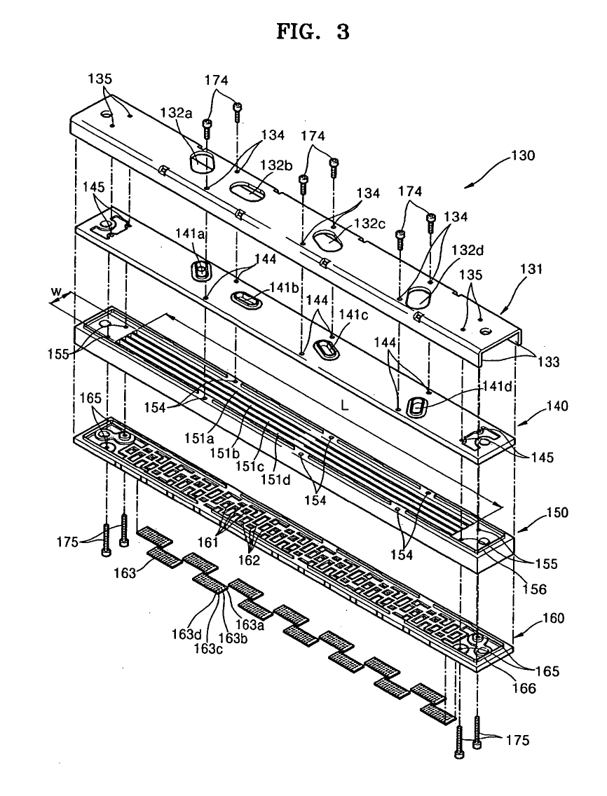

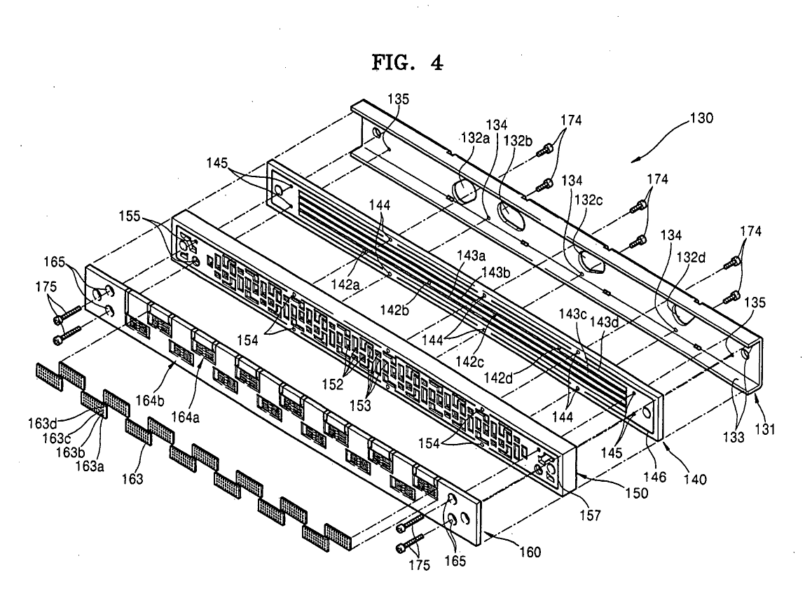

As illustrated in FIGS. 3 and 4, the array printhead 130 includes a support member 131, a first member 140, a second member 150, and a third member 160, which sequentially overlap and couple to each other.

The first, second, and third members 140, 150 and 160 are formed by molding liquid crystal polymer, which may be a polymer resin. The liquid polymer has excellent molding properties, excellent chemical durability, and a high resistance against twisting occurring due to external forces. The liquid polymer is a material having excellent measurement stability and thus is appropriate for the printhead 130 which requires a high degree of planarization and a high degree of accuracy in measurement.

The first member 140 includes four inlet holes 141a, 141b, 141c, and 141d formed to allow ink of four colors of cyan, magenta, yellow, and black from the four negative pressure regulators 125C, 125M, 125Y and 125K (refer to FIG. 2) to flow into an inside of the array printhead 130 (i.e., four ink channels 151a, 151b, 151c, and 151d of the second member 150). In detail, ink of cyan, magenta, yellow, and black may flow through a first inlet hole 141a, a second inlet hole 141b, a third inlet hole 141c, and a fourth inlet hole 141d, respectively. Four channels 143a, 143b, 143c, and 143d are formed in a lower surface of the first member 140 to separately receive ink of four colors of C, M, Y, and K, which have flowed in through the four inlet holes 141a, 141b, 141c, and 141d, respectively. Through holes 142a, 142b, 142c, and 142d are formed in the respective four channels 143a, 143b, 143c, and 143d to communicate with the four inlet holes 141a, 141b, 141c, and 141d, respectively.

The four ink channels 151a, 151b, 151c, and 151d for separately receiving ink of four colors of C, M, Y, and K, which have flowed in through the four through holes 142a, 142b, 142c, and 142d, respectively, are formed in the second member 150. The ink channels 151a, 151b, 151c, and 151d are mutually parallel to a width direction of paper, i.e., a length direction of the array printhead 130 or a direction perpendicular to a paper feeding direction of the paper P. The four ink channels 151a, 151b, 151c, and 151d may receive cyan ink, magenta ink, yellow ink, and black ink, respectively.

The four channels 143a, 143b, 143c, and 143d are formed also in a lower surface of the first member 140 in a same pattern as the four channels 151a, 151b, 151c, and 151d formed in an upper surface of the second member 150. With this construction, the channels 143a, 143b, 143c, and 143d of the first member 140 face the channels 151a, 151b, 151c, and 151 d of the second member 150, so that sufficient ink receiving spaces may be provided for the ink of four colors of C, M, Y, and K, respectively.

A rib 156 is protruded from the periphery of the upper surface of the second member 150 and a groove 146 is formed in a periphery of the lower surface of the first member 140 to receive the rib 156 of the second member 150. The rib 156 and the groove 146 serve as references when the first member 140 and the second member 150 are attached to each other. The rib 156 and the groove 146 may suppress bending and twisting of the first member 140 and the second member 150, thereby improving sealing between the first member 140 and the second member 150.

A plurality of path grooves 161 and 162 which may serve as an ink flow path that has flowed from the second member 150 may be formed in an upper surface of the third member 160. The array printhead 130 may include a plurality of head chips 163 arranged in a zigzag with respect to the width direction of paper (i.e., the length direction of the array printhead 130), so that the head chips 163 form a plurality of head chip lines. Therefore, a plurality of head chip mounting parts 164a and 164b may also be provided in a zigzag on a lower surface of the third member 160 to form the head chip lines.

To supply ink to the head chip mounting parts 164a and 164b, respectively, the plurality of path grooves 161 and 162 of the third member 160 may be repeatedly formed in the length direction of the array printhead 130 to correspond to an arrangement of the head chips 163. That is, the plurality of path grooves 161 and 162 are formed in a zigzag. Therefore, cyan ink, magenta ink, yellow ink, and black ink are respectively supplied to a first nozzle line 163a, a second nozzle line 163b, a third nozzle line 163c, and a fourth nozzle line 163d formed on the head chip 163. The ink of four colors may be supplied to one chip, so that ‘1-head chip 4-colors’ can be achieved.

A plurality of second path grooves 152 and 153 may also be formed on the lower surface of the second member 150 in a same pattern as a pattern of the path grooves 161 and 162 of the third member 160.

A rib 166 may protrude from a periphery of the upper surface of the third member 160 and a second groove 157 may be formed in a periphery of the lower surface of the second member 150 to receive the rib 166. The second rib 166 and the second groove 157 serve as references when the second member 150 and the third member 160 are attached to each other. The second rib 166 and the second groove 157 suppress bending and twisting of the second member 150 and the third member 160, thereby improving sealing between the second member 150 and the third member 160.

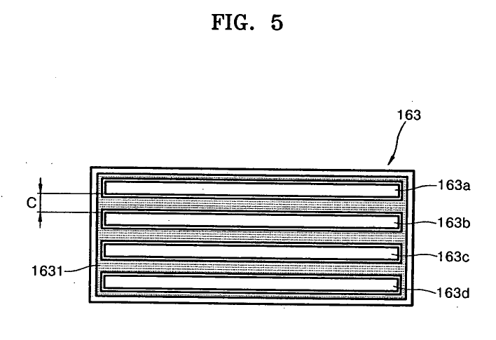

As illustrated in FIG. 5, a head chip 163 includes a plurality of nozzle lines 163a, 163b, 163c, and 163d arranged with a predetermined interval, and each of the nozzle lines 163a, 163b, 163c, and 163d includes a plurality of nozzles in the paper feeding direction (i.e., a direction perpendicular to the widthwise direction of the array printhead 130) to eject ink to an outside.

A sealant mounting part 1631 to mount a sealant is formed to enclose each of the nozzle lines 163a, 163b, 163c, and 163d between surroundings of the nozzle lines 163a, 163b, 163c, and 163d and between the nozzle lines 163a, 163b, 163c, and 163d. The sealant mounting part 1631 may be recessed a little so that the sealant may be conveniently mounted or coated thereon.

An interval C between the adjacent nozzle lines 163a, 163b, 163c, and 163d may be 0.3 mm or more. The interval 0.3 mm is determined with consideration of an amount of the sealant mounted or coated on the sealant mounting part 1631 so as to firmly mount the head chip 163 on head chip mounting parts 164a and 164b of a third member 160. The interval C should be 0.3 mm or more, so that the head chip 163 may be firmly mounted on the head chip mounting parts 164a and 164b by mounting or coating the sealant on the sealant mounting part 1631 provided at the interval C.

When the head chip 163 having the sealant mounting part 1631 on which the sealant is coated is attached on the head chip mounting parts 164a and 164b, the sealant attaches the head chip 163 to the head chip mounting parts 164a and 164b, and a space is formed in the surroundings of the nozzle lines 163a, 163b, 163c, and 163d so that ink may not mix and may not leak to the outside.

The support member 131 includes a plurality of through holes 132a, 132b, 132c, and 132d that correspond to inlet holes 141a, 141b, 141c, and 141 d of a first member 140. Therefore, since the inlet holes 141a, 141b, 141c, and 141d communicate with corresponding ones of the plurality of through holes 132a, 132b, 132c, and 132d when the first member 140 overlaps the support member 131, there is no trouble in allowing ink to be supplied from the ink tanks 122C, 122M, 122Y, and 122K.

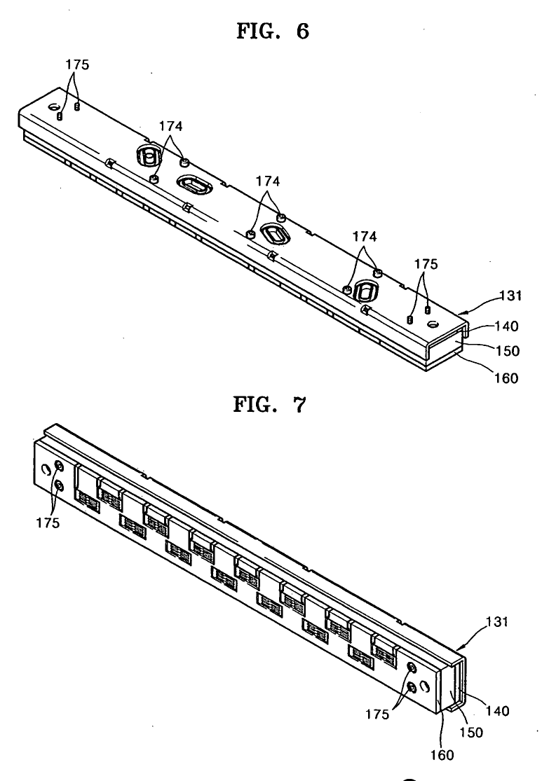

As illustrated in FIG. 3, support member 131 includes a plurality of fixing portions 133 extending from a main plate (on which the through holes 132a, 132b, 132c, and 132d are formed) by a predetermined length in a direction perpendicularly to a length direction of the support member 131. Therefore, as illustrated in FIGS. 6 and 7, a first member 140 and a second member 150 are fitted between the plurality of fixing portions 133 when the first and second members 140 and 150 overlap and couple to the support member 131.

In the present embodiment, predetermined portions of the first and second members 140 and 150 are fitted between the plurality of fixing portions 133. The first and second members 140 and 150 may be fitted between the plurality of the fixing portions 133, or all of the first, second, and third members 140, 150, and 160 may be fitted between the plurality of fixing portions 133.

The first, second, and third members 140, 150, and 160 are vertically coupled to the support member 131 using a coupling element. For that purpose, the coupling element may include first coupling parts 174 that sequentially couple the support member 131, the first member 140, and the second member 150 vertically from a first side of the support member 131, and second coupling parts 175 that sequentially couple the third member 160, the second member 150, the first member 140, and the support member 131 vertically from a second side of the support member 131. The first and second coupling parts 174 and 175 may be screws.

The support member 131 may include first and second coupling holes 134 and 135. The first member 140 includes first and second coupling holes 144 and 145, the second member 150 includes first and second coupling holes 154 and 155, and the third member 160 includes second coupling holes 165. Accordingly, the first coupling part 174 is coupled in the first coupling holes 134, 144, and 154, and the second coupling part 175 is coupled in the second coupling holes 135, 145, 155, and 165.

The first coupling hole 154 may be provided in plurality with a predetermined interval on both side portions of a width of the ink channels 151a, 151b, 151c, and 151d in the second member 150. At this point, the first coupling holes 154 may be formed so as not to interfere with rib 156. To correspond to the first coupling holes 154 in the second member 150, the first coupling holes 134 and 144 may also be formed in the support member 131 and the first member 140, respectively. The first coupling part 174 may be sequentially coupled in the first coupling holes 134, 144, and 154, so that the first and second members 140 and 150 may be coupled and fixed to the support member 131.

The second coupling hole 155 is provided in plurality on both side portions of a length of ink channels 151a, 151b, 151c, and 151d in the second member 150. To correspond to the second coupling holes 155 in the second member 150, the second coupling holes 135, 145 and 165 may also be formed in the support member 131, the first member 140, and the third member 160, respectively. The second coupling part 175 is sequentially coupled in the second coupling holes 165, 155, 145 and 135, so that the first, second, and third members 140, 150 and 160 are coupled and fixed to the support member 131.

The members 140, 150, and 160 may be formed of liquid crystal polymer and the support member 131 may be formed of stainless steel (SUS).

Though the members 140, 150, and 160 are formed of liquid crystal polymer having an excellent degree of planarization, a length of the array printhead 130 may be larger than a horizontal width of a printing medium such as paper P. For example, the array printhead length may be larger than a horizontal width (i.e., 210 mm) of A4 paper. Accordingly, when the array printhead is injection-molded, it is difficult to maintain a constant interval between the array printhead and paper in a length direction. However, since the support member 131 may be formed of metal, and thus may have excellent strength, planarization characteristics of the support member 131 may be managed, making it possible to prevent the members 140, 150, and 160 from bending by fixing the members 140, 150, and 160 using the coupling holes and coupling parts. Accordingly, it is possible to maintain a high degree of planarization by suppressing the bending of the members 140, 150, and 160.

As described above, the array printhead according to the present inventive concept has a structure where ink of four colors may be ejected through one head chip, so that a width of an ejection surface may be made narrow and thus a size thereof may be reduced. Also, unevenness of a printing medium that corresponds to the ejection surface is reduced, so that a smear phenomenon and paper jam are prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array printhead comprising:
a first member to supply ink of different colors;
a second member to separately receive the ink of different colors supplied from the first member; and
a third member to separately receive the ink from the second member,
wherein the first, second, and third members sequentially overlap and are coupled to each other, and the third member is mounted with on a lower surface thereof, a plurality of head chips where nozzles ejecting ink form a plurality of nozzle lines, and the ink of different colors is supplied to the nozzle lines, respectively.

2. The array printhead of claim 1, further comprising:
a sealant mounting part coated with a sealant to correspond to surroundings of each of the nozzle lines of the plurality of head chips so as to prevent the ink of different colors from mixing or leaking out to an outside thereof.

3. The array printhead of claim 1, wherein an interval between the adjacent nozzle lines of the plurality of head chips is 0.3 mm or more.

4. The array printhead of claim 1, further comprising:
a sealant mounted between the plurality of head chips and the third member.

5. An array printhead comprising:
a plurality of head chips disposed in a lengthwise direction, each of the plurality of head chips having a plurality of nozzle lines disposed parallel to each other in a direction having an angle with the lengthwise direction and each having a plurality of nozzles disposed thereon;
a member having an inlet, a channel disposed in the lengthwise direction to communicate with the inlet, a pass groove disposed in the direction to guide the ink from the channel in the direction, and head chip mounting parts mounted with corresponding ones of the plurality of head chips to transfer the ink from the pass groove to the plurality of head chips; and
a support member connected to the member to support the member in a body.

6. The array printhead of claim 5, further comprising:
a sealant formed around each of the nozzle lines.

7. An array printhead usable in an image forming apparatus, comprising:
a first member extended in a lengthwise direction having a plurality of inlet holes disposed in the lengthwise direction and in a direction having an angle with the lengthwise direction, and having a plurality of channels extended in the lengthwise direction and parallel to each other to receive ink from corresponding ones of the plurality of inlet holes;
a second member having a plurality of ink channels extended in the lengthwise direction to form ink passages with corresponding ones of the channels of the first member and having a plurality of pass grooves extended in the direction;
a third member having a plurality of pass grooves extended in the direction to form another ink passage with corresponding ones of the pass grooves, and having a plurality of head chip mounting parts;
a plurality of head chips mounted on corresponding ones of the plurality of head chip mounting parts; and
a support member connected to the first, second, and third members to support the first, second, and third members in the direction and the lengthwise direction.

8. The array printhead of claim 7, wherein each of the plurality of head chips ejects ink of different colors and receives the ink of different colors through the another ink passages of the third member.

9. The array printhead of claim 8, wherein the ink of different colors comprises cyan ink, magenta ink, yellow ink, and black ink and the ink of different colors is all supplied to nozzle lines of nozzles in each of the plurality of head chips.

10. An array printhead usable in an image forming apparatus, comprising:
an ink structure disposed in a lengthwise direction of the array printhead to receive ink in a receiving direction to distribute and supply ink in a plane perpendicular to the receiving direction and to output the ink received from a portion of the plane in an output direction a same as a receiving direction; and
a plurality of head chips mounted on the ink structure and having nozzles to eject ink in an ejection direction on to the recording medium, the ejection direction being a same direction as the output direction.

11. An inkjet image forming apparatus comprising:
a recording medium feeding unit to feed a recording medium in a feeding direction and in a feeding plane; and
an array printhead to eject ink in an ejection direction perpendicular to the feeding plane and onto the recording medium to form an image, the array printhead including:
an ink structure disposed in a lengthwise direction of the array printhead to receive ink in a receiving direction a same as the ejection direction and perpendicular to the feeding direction, to distribute and supply ink in a plane parallel with the feeding plane and to output the ink received in an output direction the same as the receiving direction; and
a plurality of head chips mounted on the ink structure and having nozzles to eject ink in the output direction on to the recording medium.

12. An inkjet image forming apparatus comprising:
a paper delivery element to deliver paper in one direction; and
an array printhead to eject ink onto the paper to form an image,
the array printhead including:
a first member to supply ink of different colors; and
a second member to separately receive the ink of different colors supplied from the first member; and
a third member to separately receive the ink from the second member,
wherein the first, second, and third members sequentially overlap and are coupled to each other, and the third member is mounted on a lower surface thereof, a plurality of head chips where nozzles ejecting ink form a plurality of nozzle lines, and ink of different colors is supplied to the nozzle lines, respectively.

13. The apparatus of claim 12, comprising a sealant mounting part on which a sealant is coated, to correspond to surroundings of each of the nozzle lines of the plurality of head chips so as to prevent the ink of different colors from mixing or leaking out to an outside.

14. The apparatus of claim 12, wherein interval between the adjacent nozzle lines of the plurality of head chips is 0.3 mm or more.

15. The apparatus of claim 12, further comprising:
a sealant mounted between the plurality of head chips and the third member.
